(19) United States
(12) Patent Application Publication
(10) Pub. No.: US 2025/0237928 A1
(43) Pub. Date: Jul. 24, 2025

(54) OPTICAL PHASED ARRAY

(71) Applicant: ADVANCED MICRO FOUNDRY PTE. LTD., Singapore (SG)

(72) Inventors: You Sian James TAN, Singapore (SG); Xianshu LUO, Singapore (SG)

(73) Assignee: ADVANCED MICRO FOUNDRY PTE. LTD., Singapore (SG)

(21) Appl. No.: 18/853,786

(22) PCT Filed: May 26, 2022
(86) PCT No.: PCT/SG2022/050355

§ 371 Date: Oct. 3, 2024

(51) Int. Cl. G02F 1/29

(52) U.S. Cl. CPC G02F 1/292; G02F 2201/06; G02F 2203/24

(57) ABSTRACT

An optical phased array comprises photonic components for on-chip beam forming and steering, and is adapted to use an input optical field of a beam having a wavelength which ranges from visible light to a short-wavelength infrared region. The photonic component comprises at least a waveguide and a plurality of scatterers, with each scatterer having a diagonal which is at most about one-tenth the wavelength of the input optical field.

### FIELD OF THE INVENTION

This invention relates to photonic components for on-chip beam forming, and more particularly to photonic components formed as part of a device for use in steering an optical beam.

### BACKGROUND OF THE INVENTION

Photonic components can be used to form and to steer optical beams. Such platforms, which often work in the visible, near- and short-wavelength infrared region, have found applications, including but not limited to light detection and ranging (LiDAR) systems, and free-space transceivers. In LiDAR systems, beam steering enables detecting objects, measuring their ranges and mapping their distances, and can be useful for autonomous vehicle systems and high-resolution mapping, for example. In free-space transceivers, beam steering enables wireless data to be selectively transmitted and/or received to and from a particular direction for use in data communication links such as local area networks (LAN) and light fidelity (Li-Fi).

Known approaches to optical beam steering include using mechanical free-space optical components (e.g., mirrors, prisms and lenses), liquid crystals, phase change materials, and phased arrays. In particular, phased arrays are appealing because such arrays enable beam steering without relying on any mechanical moving parts or structural change of material, such arrays are solid state and semiconductor-based, and can be realised entirely on-chip using standard CMOS-compatible fabrication processes. By modulating the optical phases of optical field to the phased array, the direction of the optical beam (emitted from the array) can be steered to a certain direction. In a typical phased array steering system, an input optical field (e.g., from a laser) is propagated through optical waveguides before the optical field is emitted into free-space via emitters. Optical phase difference between the field in adjacent emitters (e.g., in x- and/or y-directions) can determine overall beam directionality. Feedback signals to a controller to fine tune the optical phases to the emitters is typically required to enhance beam directionality.

In recent years, there have been efforts to reduce such aforementioned cumbersome reliance on feedback signals for beam directionality enhancement. Example of this effort includes exploiting the periodic nature of optical phases of the optical field in waveguides. For instance, U.S. Patent Publication 20201/0382371 issued to Ni et al. discloses photonic components formed from a waveguide and an array of emitters in the form of meta-atoms. These meta-atoms are formed from specifically designed gold/dielectric/gold sandwich structure positioned on top of a waveguide. The specific sandwich design is required to enable interactions between electric dipoles in the structure, in order to induce additional optical phase shift inherent to the approach. The meta-atoms are structurally complex, which increases fabrication complexity and costs to assemble, especially when using conventional lithographic techniques. Moreover, because Ni et al. requires multiple meta-atoms for each repeating unit of emitters, the optical loss in the waveguide after each repeating unit is substantially higher, which limits the scalability of the approach, and thus aperture size of the device (typically <mm scale). Increasingly, a large effective aperture size is desired for several reasons, including: to increase the lateral or angular resolution of the emitted beam (resolution∝wavelength÷effective aperture size); to reduce the effect that obscurants have on the system (‘dead bug problem’); and to enable more optical power to be emitted without exceeding eye-safe power density. For 0.1° resolution in the telecommunications wavelength (˜1.55 μm), aperture size of a few hundred μm is often preferred. This is challenging with the approach in Ni et al. because of the lack of scalability of the device in the work. In LiDAR systems, such high resolution enables fine target/object addressability.

It would be desirable to provide an improved photonic component of elegant design and with an enhanced effective aperture size which can improve lateral and/or angular resolution.

### SUMMARY OF THE INVENTION

In accordance with a first aspect, there is provided an optical phased array comprises photonic components for on-chip beam forming and steering, and is adapted to use an input optical field of a beam having a wavelength which ranges from visible light to a short-wavelength infrared region. The photonic component comprises

at least a waveguide and a plurality of scatterers, with each scatterer having a diagonal or diameter which is at most one-tenth the wavelength of the input optical field. Such an optical phased array is useful in LiDAR systems, and transceivers.

From the foregoing disclosure and following more detailed description of various embodiments it will be apparent to those skilled in the art that the present invention provides a significant advance in the technology of optical phased arrays. Particularly significant in this regard is the potential the invention affords for providing a relatively low cost and straightforward construction. Additional features and advantages of various embodiments will be better understood in view of the detailed description provided below.

### BRIEF DESCRIPTION OF THE DRAWINGS

FIG. 1 is a partial isometric view of a waveguide and arrayed scatterers for on-chip beam forming and steering in accordance with one embodiment of the optical phased array.

FIG. 2 is a side view of the waveguide and arrayed scatterers of FIG. 1.

FIG. 3 is a table showing an estimated resulting z-component of an electric field in accordance with several embodiments of the photonic components disclosed herein at different wavelengths, and also resulting polar plots showing far field intensities.

FIG. 4 is another table showing variations in an estimated resulting z-component of the electric field in accordance with several embodiments of the photonic components disclosed herein at different pitch distances, and also resulting polar plots showing far field intensities.

FIG. 5 is a table comparing polar plots of resulting far field intensities at different optical phase differences of an optical field send to the waveguides Δφ_{y} (that is, phase difference Δφ in the y-direction).

FIG. 6 shows a modeled electric field magnitude plot for a waveguide using a conventional grating that comprises Mie scatterers.

FIG. 7 shows a modeled electric field magnitude plot for a waveguide using a plurality of Rayleigh scatterers in accordance with one embodiment.

FIG. 8 shows a schematic diagram of columns of a phased array of photonic components in accordance with certain embodiments disclosed herein.

FIG. 9 shows a schematic diagram of rows of a phased array of photonic components in accordance with certain embodiments disclosed herein.

FIG. 10 shows a schematic diagram of rows of a phased array of photonic components in accordance with certain embodiments disclosed herein, at a last column.

FIG. 11 shows a schematic diagram illustrating a relation between the directionality of scattered optical beam θₓ in the x-axis on a row m, and the optical phases of the optical field φₘₙ scattered out-of-plane by the scatterer positioned at the columns n of the phased array in accordance with one embodiment.

FIG. 12 shows a schematic diagram illustrating a relation between the directionality of optical beam θ_{y} scattered out-of-plane in the y-axis on column n=1, and the optical phases of the optical field φₘ₁ scattered out-of-plane by scatterer positioned at the rows m of the phased array in accordance with one embodiment.

It should be understood that the appended drawings are not necessarily to scale, presenting a somewhat simplified representation of various features illustrative of the basic principles of the invention. The specific design features of the optical phased array as disclosed here, including, for example, the specific dimensions of the

scatterer, will be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the optical phased array disclosed here. The following detailed discussion of various alternate features and embodiments will illustrate the general principles of the invention with reference to a photonic component suitable for use as part of an optical phased array. Such an optical phased array may be used as a beam steering system that can be part of LiDAR systems, and free-space transceivers, for example. Other embodiments suitable for other applications will be apparent to those skilled in the art given the benefit of this disclosure.

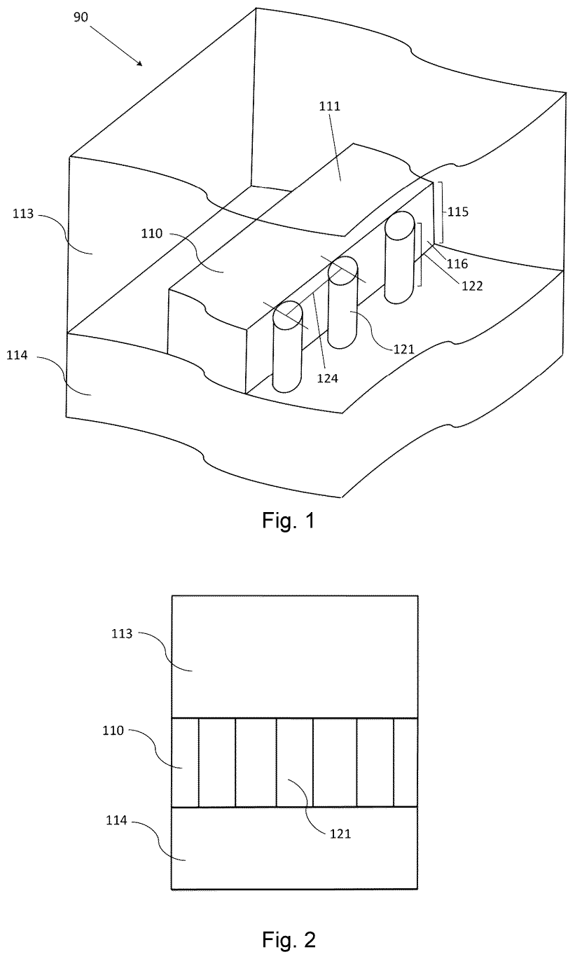

Turning now to the drawings, FIG. 1 is a schematic view of an optical phased array having a photonic component 90 in accordance with one embodiment, suitable for on-chip beam forming and steering. Such an optical phased array can be used in many applications, such as LiDAR. The optical field input source can be for example, from a laser having a wavelength. The optical phased array can act as a transceiver emitting/receiving an optical beam to/from an object in a controlled manner. Part of the optical beam emitted is reflected back to the phased array for processing. Optionally the wavelength of the input optical field can be in the short wavelength infrared region of the electromagnetic spectrum at 1.4 μm to 1.7 μm, for example. Visible wavelengths (0.38 μm to 0.75 μm), and near-infrared wavelengths (0.75 μm to 1.4 μm) may also be used, depending upon the application of the photonic component. The photonic component 90 is shown with a waveguide 110 and a plurality of scatterers 121 positioned along the waveguide. The waveguide 110 may be circular or may be a rectangular (rib or ridged) waveguide. A refractive index of the core layer 110 can be larger than that of the surrounding waveguide cladding. The waveguide cladding can comprise undercladding 114 and overcladding 113.

The optical phased array can be implemented fully on-chip using photonic circuit components 90. Advantageously, such photonic components can be produced using standard fabrication techniques, such as lithography and deposition, and standard photonic materials including but are not limited to silicon (Si), silicon nitride

(Si₃N₄), germanium (Ge), lithium niobate (Li₃NbO₃) and indium phosphide (InP), for example. The phased array comprises at least one (M≥1) of optical waveguides 110, each having a plurality (N) of optical nanostructure arrays (also referred to as scatterers or emitters), representing M columns and N rows of the phased array 100. Only one optical waveguide 110 and three scatterers 121 are shown in FIG. 1 for clarity. However, the optical phased array can be scaled up to have any number M×N of optical waveguides and scatterers. Each m of the M optical waveguides 110 is configured to receive an optical field of wavelength λₒ that can be represented using the plane wave approximation αe^{iφ}_{in,m}, with α and φ_{in,m} respectively denoting the amplitude and phase of the optical field sent to each of the waveguides.

In accordance with a highly advantageous element, the rectangular waveguide shown in the embodiment of FIG. 1 has an elongate top surface 111, and side walls 116 extending down from the top surface 111. A plurality of scatterers 121 are positioned along at least one of the side walls of the waveguide, and can be positioned

along both side walls. The scatterers should be positioned at least generally adjacent the side walls 116 of the waveguide 110, and optionally the plurality of scatterers 121 are in contact with corresponding side of the waveguide 110, as shown in FIG. 1. The plurality of scatterers may also be embedded in the waveguide; the scatterers can be formed as either unitary portions of the waveguide or as integral portions, for example.
Also, the scatterers 121 can be equidistantly spaced apart from one another by a pitch distance 124, and preferably are each formed having the same height 122. The scatterers may each comprise a dielectric material, such as Si, Si₃N₄, Ge, Li₃NbO₃, InP, and polymers, for example. The waveguide side walls 116 have a thickness 115, and the plurality of scatterers 121 each have a height 122. Preferably the thickness 115 of the side wall 116 of the waveguide 110 is equal to the height 122 of the plurality
of scatterers 121. Advantageously the scatterers can be positioned free of the top surface 111 of the waveguide, as shown in FIGS. 1 and 2. The waveguide core 110 has refractive index higher than the surrounding waveguide cladding 113.

The wavelength range of the input optical field ranges from visible to short-wavelength infrared light. Preferably each scatterer 121 of the plurality of scatterers are generally rectangular prism or cylindrical shaped and have a cross-section such as a diagonal or diameter D (when the scatterers are cylindrical) which is at most about one-tenth of the wavelength of the incident optical field (i.e., from the input optical field which can range from visible to the short-wavelength infrared). Such optical field scattering is referred to as Rayleigh scattering. Each Rayleigh scatterer is an example of an emitter that emits an optical field having an emitted optical intensity that is less than 5% of the optical intensity of the optical field of the beam incident onto the emitter. Rayleigh scattering can be contrasted with Mie scattering which refers primarily to scattering of the optical field from scatterers whose diameter is substantially more than one tenth the wavelength of the incident optical field. See for example known grating couplers which adopt Mie scatterers in the form of gratings in Taillaert et al., Appl. Phys. 45, 2006. Rayleigh scattering formed by the photonic components disclosed herein is discussed in greater detail below.

The waveguide can comprise any of several different types of waveguide. For example, the waveguide can be a total internal reflection-based waveguide (which makes up the overwhelming majority of optical waveguides traditionally used in integrated photonics), a slot waveguide, and surface plasmon polariton waveguide. Alternatively, in-plane scattering waveguide may be used, such as waveguide formed from photonic crystals (which also use total internal reflection) and metamaterials. A composition of the waveguide can be, for example, at least one of Si, Si₃N₄, Ge, Li₃NbO₃, InP, and polymers, for example. The waveguide can support any of the optical waveguide modes. For example, Transverse Electric mode and Transverse Magnetic mode. In LiDAR systems, a controller can be adapted to work with the waveguide 110 and the scatterer 121 and receive an emitted optical field reflected from the object, and incorporate a processor to calculate the information about the surface characteristics of the object based on the reflected light received by the scatterers and the waveguide.

In addition to the wavelength of the optical input field, another important variable that determines beam directionality is the scatterer pitch distance, which is the distance between adjacent scatterers where a plurality of scatterers are used. For example, as shown in FIG. 1, a series of scatterers may be formed in a line, with each

scatterer separated from an adjacent scatterer by the scatterer pitch distance d. The scatterers may be apodised, that is the diagonal or diameter of the scatterers may be graded or varied continuously along the length of the series of scatterers. The optical phases of the optical field at the perturbing scatterers (as emitters) can be accurately determined from the periodic nature of the optical field in the waveguide. Advantageously, by using photonic components as disclosed herein, the beam can be formed over a field-of-view of greater than 100 degrees, or more preferably greater than 150 degrees. Use of wavelength division multiplexing enables forming of a beam with broad directionality. The directionality of the beam emitted is discussed in greater detail below.

Beam directionality (or beam steering angle) is a function of emitter pitch d, the distance 124 between centers of neighbouring scatterers which act as emitters. The equation which relates d with beam directionality e is:

$$θ = {sin}^{- 1} ( \frac{{λ}_{eff , fs}}{2 d} \frac{Δ ϕ}{π} ) \qquad ( 1 )$$

where
λ_{eff,fs}=λₒ/n_{eff,fs}, is the effective wavelength of optical field in free-space,
λₒ is the wavelength of the optical field,
n_{eff,fs} is the effective refractive index of the medium in free space, and
Δφ, is the optical phase difference of the optical field at the emitters/scatterers 121.

From Equation (1) above, a beam steering range Δφ, can be defined to be:

$$- {sin}^{- 1} ( \frac{{λ}_{eff , fs}}{2 d} \frac{Δϕ}{π} ) < Δ θ < {sin}^{- 1} ( \frac{{λ}_{eff , fs}}{2 d} \frac{Δ ϕ}{π} ) \qquad ( 2 )$$

Thus, for a complete 180° (or u radians) beam steering range, we can have [−90°, 90°]. The complete 180° beam steering range (or field-of-view) is satisfied by the following relationship:

$$\frac{{λ}_{eff , fs}}{2 d} \frac{Δϕ}{π} = 1 \qquad ( 3 )$$

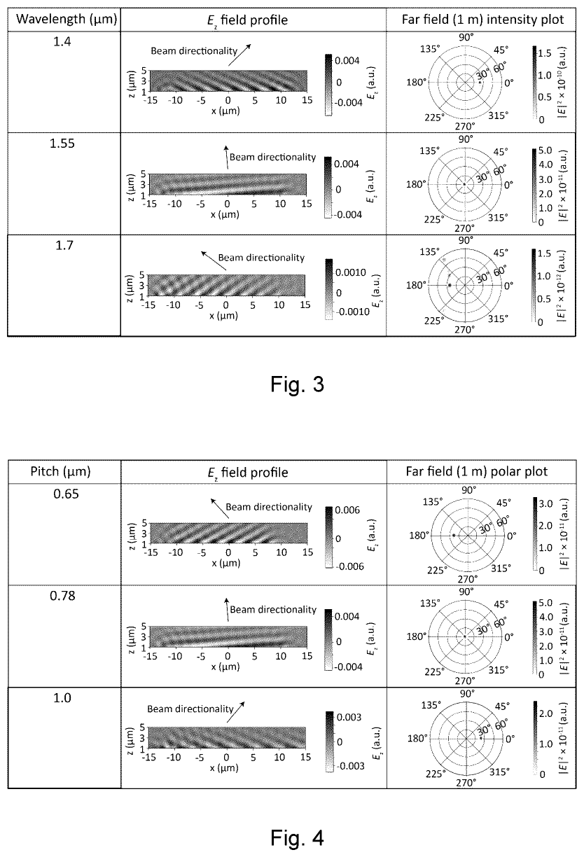

FIG. 3 is a table showing finite-difference time-domain (FDTD) numerically simulated resulting z-component of the electric field (E_{z}) profiles of embodiments of the photonic components at d=0.78 μm along an xz-cross section disclosed at different wavelengths (1.4 μm, 1.55 μm and 1.7 μm in the three examples of the model of FIG. 3), and also a polar plot of resulting far field intensities with respect to an azimuth and zenith viewing angle. From Equation 1, in particular for e in the x-direction

(or θₓ; direction specified in the subscript), it can be determined that when Δφ=0, that is, when d=λ_{eff,wg} where λ_{eff,wg}=λₒ/n_{eff,wg} is the effective wavelength of the optical field in the waveguide (in our case λ_{eff,wg}=0.78 μm) and n_{eff,wg} is the effective refractive index of the waveguide medium, the scattered (or emitted) optical field propagates in
free space in a direction exactly perpendicular to the waveguide structure. Changing λ_{eff,wg}/d and/or Δφ shifts the beam directionality from a vertically perpendicular direction (in the z-axis). For example, in accordance with one embodiment using 1.55 μm wavelength as the optical field, the scatterer is formed from Si can have a diameter of about 160 nm, the waveguide supports Transverse Magnetic optical waveguide mode with 0.3 μm width and 0.3 μm side wall thickness or height, along with air overcladding and SiO₂ undercladding.

FIG. 4 is another table similar to FIG. 3, but variations in an estimated resulting z-component of the electric field E_{z} field profiles of additional embodiments of the photonic components along the xz-cross section disclosed herein at different pitch distances 124 (0.65 μm, 0.78 μm and 1.0 μm in the three examples in the model of FIG. 4), and also a polar plot of resulting far field intensities with respect to azimuth and zenith viewing angle.

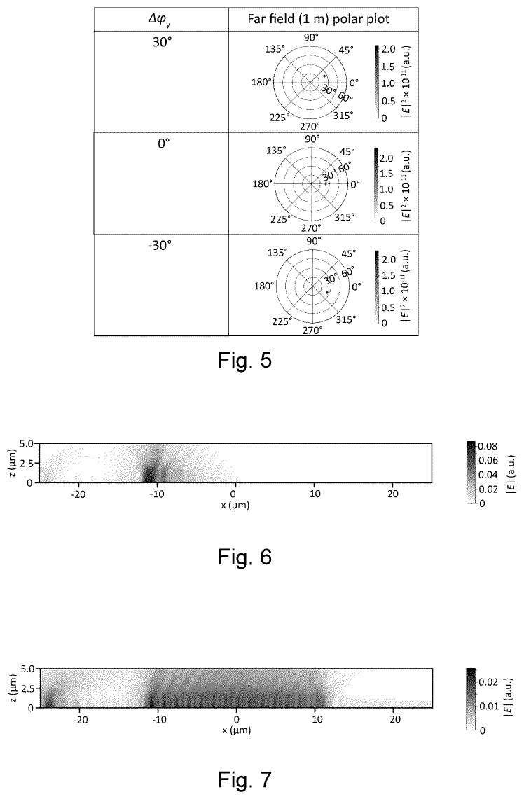

FIG. 5 is another table comparing polar plots of resulting far field intensities with respect to an azimuth and a zenith viewing angle at different optical phase differences of the input optical field sent to the waveguides Δφ_{y} (that is, optical phase Δφ in the y-direction).

FIGS. 6 and 7 compares and contrasts known Mie scattering with the photonic components incorporating Rayleigh scattering disclosed herein. FIG. 6 shows an FDTD numerically-simulated plot of the modeled electric field magnitude along the xz-cross section for a waveguide using a conventional grating comprising a plurality of Mie scatterers. The scatterers are formed from Si with 0.4 μm length and 0.4 μm width, the waveguide supports Transverse Magnetic optical waveguide mode with 0.3 μm width and 0.3 μm side wall thickness or height, along with air overcladding and SiO₂ undercladding. The optical intensity of scattered radiation from each Mie scatterer can be orders of magnitude larger than that from Rayleigh scatterers. As a result, the remaining optical field in the waveguide after encountering each individual Mie scatterer is weak, resulting in spatially concentrated scattered (or emitted) field, mainly from the first few scatterers, overall. This is not desirable because the directionality of the scattered beam from the phased array does not stem from a single or only a few scatterers, but from many scatterers. By contrast, FIG. 7 shows an FDTD numerically-simulated plot of the modeled electric field magnitude along the xz-cross section for a waveguide using a plurality of Rayleigh scatterers (in this model, 30 scatterers) in accordance with one embodiment of the present invention. The optical intensity of the scattered radiation from each Rayleigh scatterer is relatively weak compared to the case from each Mie scatterer. For example, with the optical phased arrays disclosed herein, out-of-plane scattering, that is scattering which is out of the xy-plane (or in-plane) defined by the photonic components, is low, such as less than 5% intensity of the beam. As a result, the remaining optical field in the waveguide after encountering each individual scatterer remains significant, resulting in a more distributed and uniform scattered (or emitted) field overall. This is desirable because the directionality

of the scattered beam from an optical phased array is generated from many scatterers, instead of just a few.

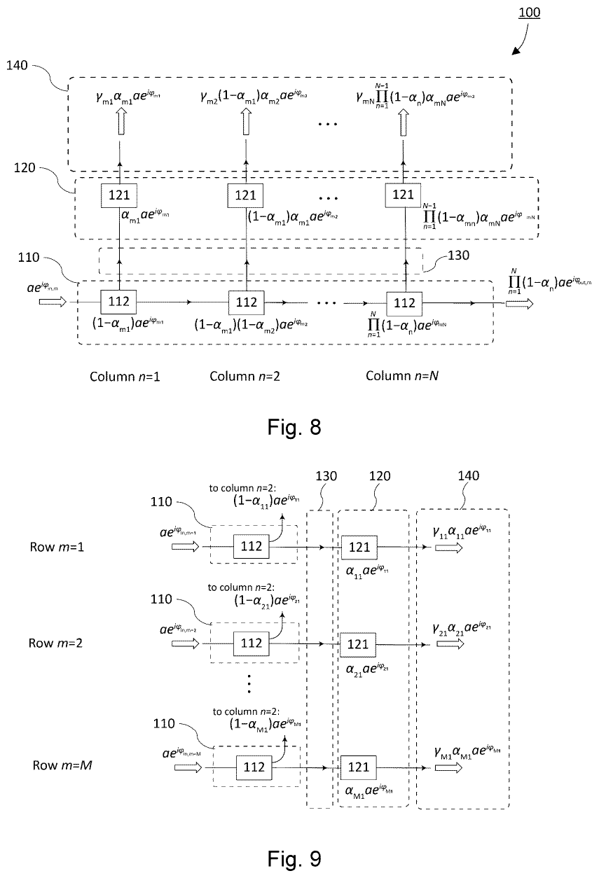

FIG. 8 shows a schematic diagram of columns (N) of the optical phased array on row m, according to an embodiment of the invention. The optical phased array can comprise an array of operatively connected photonic components formed in rows and columns. Each row 100 comprises a plurality 120 of Rayleigh scatterers 121 that perturb the optical waveguide 110. The Rayleigh scatterers are placed at the periodic points 112 generally adjacent to the waveguides 110. Each Rayleigh scatterer 121 causes a portion of optical field from the waveguide (with α and φ_{in,m} respectively denoting the amplitude and phase of the optical field) to be evanescently coupled 130 (by the factor α) and scattered out-of-plane 140 (by the factor γ). The subscripts m and n respectively denote the array row and column.

FIG. 9 shows a schematic diagram similar to FIG. 8, but showing the rows of the optical phased array on the first (n=1) column, according to an embodiment of the invention. Each column comprises a plurality of optical waveguides 110 perturbed by a row 120 of Rayleigh scatterers 121 positioned at the points 112 along the waveguides 110. Each Rayleigh scatterer 121 causes a portion of the optical field from

the waveguide (with a and φ_{in,m} respectively denoting the amplitude and phase of the optical field) to be evanescently coupled 130 (by the factor α) and be scattered out-of-plane 140 (by the factor γ). The subscripts m and n respectively denote the array row and column.

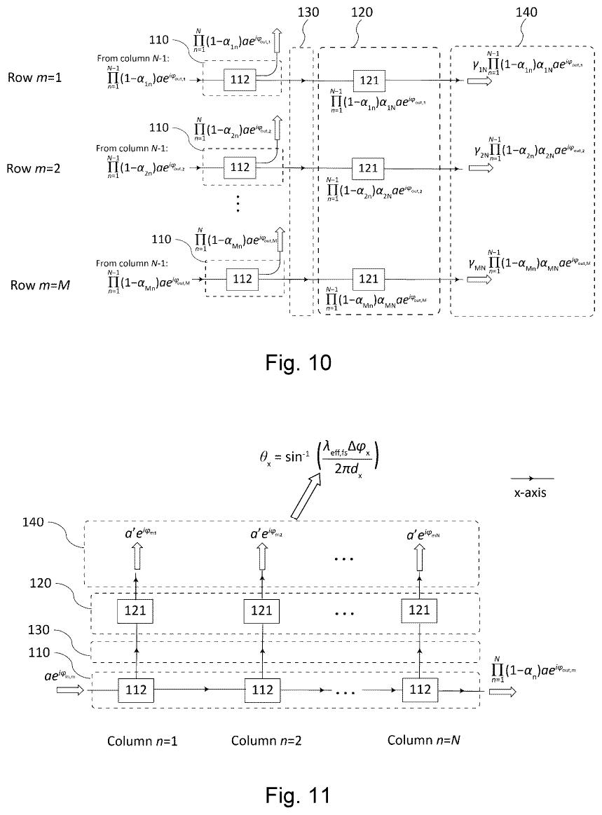

FIG. 10 shows a schematic diagram of the rows of the optical phased array on the last (n=N) column, and also resulting a portion of optical field from the waveguides 110 (with α and φ_{in,m} respectively denoting the amplitude and phase of the optical field)

to be evanescently coupled 130 (by the factor α) and be scattered out-of-plane 140 (by the factor γ) by the Rayleigh scatterers 121, according to one embodiment. The subscripts m and n respectively denote the array row and column.

FIG. 11 shows a schematic diagram illustrating the relation between the directionality of scattered optical beam in the x-axis θₓ on row m, and the optical phases of the optical field from the waveguide (with α and φ_{in,m} respectively denoting the amplitude and phase of the optical field) to be evanescently coupled 130 (by the factor α) and be scattered out-of-plane 140 (by the factor γ) by the Rayleigh scatterers 121 positioned at the columns n of the optical phased array, according to one embodiment. The subscripts m and n respectively denote the array row and column. λ_{eff,fs}, Δφₓ, and dₓ are respectively the effective wavelength of the optical field in free-space, the optical phase difference of the optical field at the Rayleigh scatterers (in the x-direction), and Rayleigh scatterer pitch (in the x-direction). α′ is the approximated amplitude of the optical field scattered out-of plane from each Rayleigh scatterer (considering waveguide-scatterer evanescent coupling factor α<<1 and out-of-plane scattering factor γ<<1 due to Rayleigh scattering).

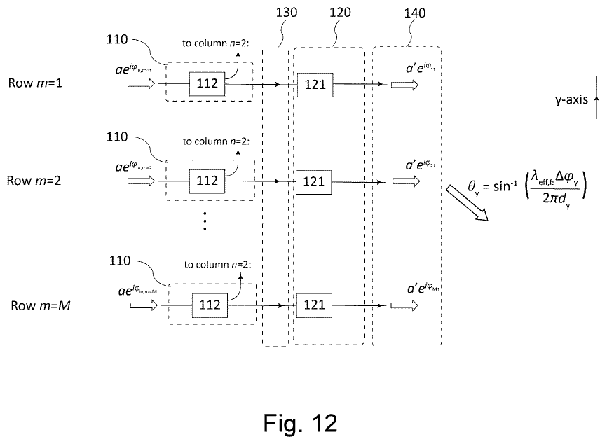

FIG. 12 shows a schematic diagram illustrating the relation between the directionality of optical beam scattered out-of-plane θ_{y} in the y-axis on column n=1 and the optical field from the waveguide (with α and φ_{in,m} respectively denoting the amplitude and phase of the optical field) be evanescently coupled 130 and be scattered out-of-plane 140 by Rayleigh scatterers 121 positioned at the rows m of the optical phased array, according to one embodiment. The relation applies to Rayleigh scatterers of other columns n. The subscripts m and n respectively denote the array row and column. λ_{eff,fs}, Δφ_{y}, and d_{y} are respectively the effective wavelength of an optical field in free-space, the optical phase difference of the optical field at the Rayleigh scatterers (in the y-direction), and Rayleigh scatterer pitch (in the y-direction). α′ is the approximated amplitude of the optical field scattered out-of-plane from each

Rayleigh scatterer (considering waveguide-scatterer evanescent coupling factor α<<1 and out-of-plane scattering factor γ<<1 due to Rayleigh scattering).

From the foregoing disclosure and detailed description of certain embodiments, it will be apparent that various modifications, additions and other alternative embodiments are possible without departing from the true scope and spirit of the

invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An optical phased array comprising at least one photonic component for on-chip to free space beam forming and steering, adapted to use an input optical field of a beam having a wavelength which ranges from visible light to a short-wavelength infrared region, the photonic component comprising, in combination:
a waveguide and a plurality of scatterers each having a diagonal which is at most one-tenth the wavelength of the input optical field,
wherein the plurality of scatterers are in contact with corresponding side walls of the waveguide.

2. The optical phased array of claim 1 wherein the beam formed by the photonic components has an optical intensity, the photonic components define an xy-plane, and scattering of the beam out of the xy-plane comprises an optical field emitted from each scatterer with an emitted optical intensity less than 5% of the optical intensity that is incident onto the scatterer.

3. The optical phased array of claim 1 wherein the waveguide is a rectangular waveguide having an elongate top surface and side walls extending from the top surface.

4. The optical phased array of claim 1 wherein the scatterers of the plurality of scatterers are equidistantly spaced apart from one another by a pitch distance.

5. The optical phased array of claim 1 wherein the plurality of scatterers each comprise a dielectric material.

6. The optical phased array of claim 1 formed as an array of photonic components comprising columns and rows.

7. The optical phased array of claim 1 wherein the waveguide is any one of a total internal reflection-based waveguide, and an in-plane scattering waveguide.

8. The optical phased array of claim 1 wherein the scatterers are cylindrical and the diagonal is a diameter.

9. The optical phased array of claim 1 wherein the scatterers are embedded in the waveguide.

10. (canceled)

11. The optical phased array of claim 1 further comprising scatterers positioned on opposite side walls of the waveguide.

12. The optical phased array of claim 1 wherein the plurality of scatterers are apodised.

13. The optical phased array of claim 2 wherein the beam formed has a field-of-view of greater than 100 degrees.

14. The optical phased array of claim 3 wherein the waveguide side walls have a thickness, and the plurality of scatterers each have a height, wherein the thickness of the side walls is equal to the height of the plurality of scatterers.

15. The optical phased array of claim 3 wherein the waveguide comprises at least one of Si, Si3N4, Ge, Li3NbO3, InP and a polymer.

16. The optical phased array of claim 5 wherein the dielectric material is at least one of Si, Si3N4, Ge, Li3NbO3, InP and a polymer.

17. The optical phased array of claim 6 further comprising a controller operatively connected to the optical phased array, and adapted to receive an emitted optical beam reflected from an object and to calculate information about surface characteristics of the object based on reflected light received by the scatterers and the waveguide.

18. The optical phased array of claim 12 wherein the beam formed has a field-of-view of greater than 150 degrees.
